(19) United States
(12) Patent Application Publication
(10) Pub. No.: US 2025/0245041 A1
(43) Pub. Date: Jul. 31, 2025

(54) OUT-OF-ORDER EXECUTION FOR GRAPHICS PROCESSING UNIT HARDWARE

(71) Applicant: QUALCOMM Incorporated, San Diego, CA (US)

(72) Inventors: Vishwanath Shashikant NIKAM, Bangalore (IN); Akash Sitaram ATHREYA, Bangalore (IN); Siva Satyanarayana KOLA, Bangalore (IN); Kalyan Kumar BHIRAVABHATLA, Bengaluru (IN); Chun YU, Rancho Santa Fe, CA (US); Jian LIANG, San Diego, CA (US)

(21) Appl. No.: 18/424,643

(22) Filed: Jan. 26, 2024

(51) Int. Cl. G06F 9/48; G06T 15/00

(52) U.S. Cl. CPC G06F 9/4881; G06T 15/005

(57) ABSTRACT

Aspects presented herein relate to methods and devices for data or graphics processing including an apparatus, e.g., a GPU. The apparatus may obtain an indication of a plurality of workloads for graphics processing. The apparatus may also perform a binning process for a first workload of the plurality of workloads. Further, the apparatus may divide the first workload into a plurality of first sub-workloads and a second workload of the plurality of workloads into a plurality of second sub-workloads. The apparatus may also perform a rendering process for at least one first sub-workload of the plurality of first sub-workloads and a binning process for at least one second sub-workload of the plurality of second sub-workloads. The apparatus may also perform a rendering process for the at least one second sub-workload prior to a completion of the rendering process for the at least one first sub-workload.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform for graphics processing. The apparatus may obtain an indication of a plurality of workloads for graphics processing, where the plurality of workloads corresponds to a workload order for a workload submission sequence. The apparatus may also perform a binning process for a first workload of the plurality of workloads, where the first workload is first in the workload order. The apparatus may also divide the first workload into a plurality of first sub-workloads and a second workload of the plurality of workloads into a plurality of second sub-workloads, where the second workload is second in the workload order. Additionally, the apparatus may allocate the plurality of first sub-workloads and the plurality of second sub-workloads to a preconfigured storage after the division of the first workload and the second workload. The apparatus may also execute a memory read process for the at least one first sub-workload prior to the performance of the rendering process for the at least one first sub-workload. Moreover, the apparatus may divide each of the plurality of first primitive batches into a plurality of first primitive sub-batches and each of the plurality of second primitive batches into a plurality of second primitive sub-batches. The apparatus may also combine each of the plurality of first primitive sub-batches into a group of first vertices and each of the plurality of second primitive sub-batches into a group of second vertices, where the group of first vertices is associated with a first granularity and the group of second vertices is associated with a second granularity. The apparatus may also execute, at a shader processor (SP) of a graphics processing unit (GPU), the group of first vertices at the first granularity and the group of second vertices at the second granularity. Further, the apparatus may perform, upon completion of the binning process for the first workload, a rendering process for at least one first sub-workload of the plurality of first sub-workloads and a binning process for at least one second sub-workload of the plurality of second sub-workloads. The apparatus may also execute a memory read process for the at least one second sub-workload prior to the completion of the rendering process for the at least one first sub-workload and prior to the performance of the rendering process for the at least one second sub-workload. The apparatus may also perform a rendering process for the at least one second sub-workload prior to a completion of the rendering process for the at least one first sub-workload. The apparatus may also output an indication of the performance of the rendering process for the at least one second sub-workload prior to the completion of the rendering process for the at least one first sub-workload.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 is a diagram illustrating example processing components.

FIG. 4 is a diagram illustrating an example image or surface.

FIG. 5 is a diagram illustrating an example geometry pipeline.

FIG. 6 is a diagram illustrating an example GPU hardware.

FIG. 7 is a diagram illustrating an example execution sequence.

FIG. 8 is a diagram illustrating an example GPU hardware.

FIG. 9 is a diagram illustrating an example execution sequence.

FIG. 10 is a communication flow diagram illustrating example communications between a GPU, a CPU/GPU, and a memory.

FIG. 11 is a flowchart of an example method of graphics processing.

FIG. 12 is a flowchart of an example method of graphics processing.

### DETAILED DESCRIPTION

In some aspects, different types of GPU hardware may support different types of workload execution. For instance, GPU hardware may support concurrent execution of different workloads. Concurrent execution may refer to the simultaneous execution of workloads at a GPU. Also, concurrent execution may refer to the execution of workloads in parallel at a GPU. GPU hardware may also support concurrent execution of different workloads in a time-shared manner. In some instances, concurrent execution of different workloads in a time-shared manner may improve the performance per area at the GPU. However, in other instances, concurrent execution of different workloads in a time-shared manner may reduce the performance per area at the GPU. Additionally, different types of workloads may take a different amount of processing time in various stages of the GPU pipeline. Also, these types of workloads may introduce inefficiency in GPU hardware utilization. Certain types of workloads (e.g., sorting workloads) may face higher memory access latencies compared to other types of workloads (e.g., render workloads). For example, render workloads may be of higher priority than sorting workloads, which may face higher memory access latencies. In some aspects, if these types of workloads (e.g., sorting workloads) are executed in-order as per the scheduled workload sequence and granularity, there may be a reduction in hardware efficiency. For instance, if these types of workloads (e.g., sorting workloads) are executed in-order as per the scheduled workload sequence and granularity, a certain workload block (e.g., a head-of-line block) may occur, thus reducing the hardware efficiency. In some instances, there may be a problem at the vertex data fetch and decode stage in the geometry pipeline. Similar problems exist at the shader processor input stage. For instance, the output buffers may be ready with data, but may not be processed further as the GPU pipeline may choose to follow a pre-determined execution order. In general, this problem may show up at any GPU pipelined hardware that is shared for the execution of multiple types of threads with different execution profiles (e.g., memory latency, arithmetic logic unit (ALU) execution time, etc.). That is, delay issues may exist if workloads are executed in order, such that there may be stalling with one workload. Indeed, that may be idle periods and/or stalling in workload execution due to the GPU hardware reading the memory in order. This may result in delayed processing times, as well as an increased amount of processing power at the GPU. Aspects of the present disclosure may alter an execution order for certain types of workloads (e.g., graphics workloads). For instance, aspects of the present disclosure may execute workloads out of a certain order (e.g., a pre-defined workload execution order). That is, aspects presented herein may utilize certain types of hardware (e.g., time-shared hardware) to execute workloads out-of-order.

Aspects of the present disclosure may include a number of benefits or advantages. For instance, aspects presented herein may alter an execution order for certain types of workloads (e.g., graphics workloads). That is, aspects of the present disclosure may execute workloads out of a certain order (e.g., a pre-defined workload execution order). Aspects presented herein may utilize certain types of hardware (e.g., time-shared hardware) to execute workloads out-of-order. Also, aspects presented herein may utilize a time-shared GPU processing pipeline to execute certain workloads (e.g., graphics workloads) in an out-of-order timeline. Aspects presented herein may execute workloads out-of-order for a time-shared processing pipe, which may result in a faster and more efficient execution of workloads. By executing workloads in an out-of-order fashion, aspects presented herein may avoid any stalls or idle periods during workload execution. That is, aspects presented herein may execute workloads more efficiently. Further, aspects presented herein may experience an increase in terms of frames-per-second (FPS) execution. For example, aspects presented herein may experience an execution increase of 2% or 2.25% FPS.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

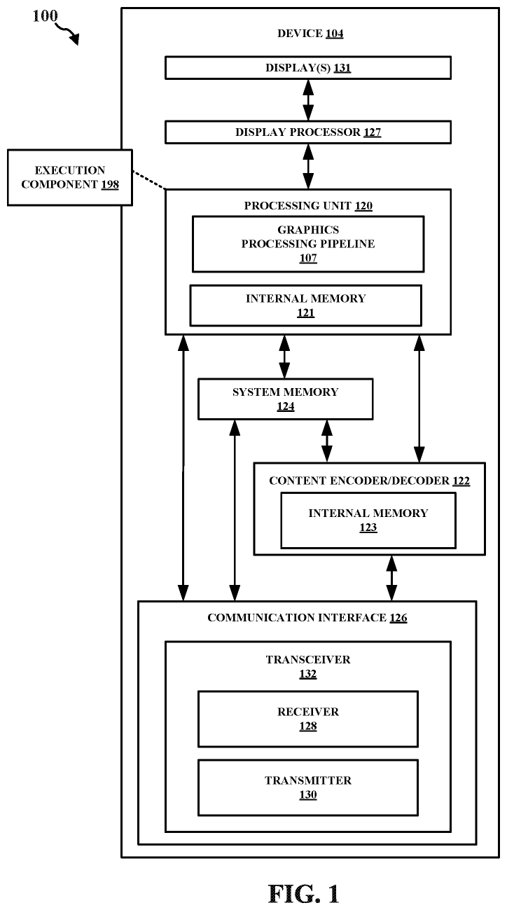

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content. The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an execution component 198 configured to obtain an indication of a plurality of workloads for graphics processing, where the plurality of workloads corresponds to a workload order for a workload submission sequence. The execution component 198 may also be configured to perform a binning process for a first workload of the plurality of workloads, where the first workload is first in the workload order. The execution component 198 may also be configured to divide the first workload into a plurality of first sub-workloads and a second workload of the plurality of workloads into a plurality of second sub-workloads, where the second workload is second in the workload order. The execution component 198 may also be configured to allocate the plurality of first sub-workloads and the plurality of second sub-workloads to a preconfigured storage after the division of the first workload and the second workload. The execution component 198 may also be configured to execute a memory read process for the at least one first sub-workload prior to the performance of the rendering process for the at least one first sub-workload. The execution component 198 may also be configured to divide each of the plurality of first primitive batches into a plurality of first primitive sub-batches and each of the plurality of second primitive batches into a plurality of second primitive sub-batches. The execution component 198 may also be configured to combine each of the plurality of first primitive sub-batches into a group of first vertices and each of the plurality of second primitive sub-batches into a group of second vertices, where the group of first vertices is associated with a first granularity and the group of second vertices is associated with a second granularity. The execution component 198 may also be configured to execute, at a shader processor (SP) of a graphics processing unit (GPU), the group of first vertices at the first granularity and the group of second vertices at the second granularity. The execution component 198 may also be configured to perform, upon completion of the binning process for the first workload, a rendering process for at least one first sub-workload of the plurality of first sub-workloads and a binning process for at least one second sub-workload of the plurality of second sub-workloads. The execution component 198 may also be configured to execute a memory read process for the at least one second sub-workload prior to the completion of the rendering process for the at least one first sub-workload and prior to the performance of the rendering process for the at least one second sub-workload. The execution component 198 may also be configured to perform a rendering process for the at least one second sub-workload prior to a completion of the rendering process for the at least one first sub-workload. The execution component 198 may also be configured to output an indication of the performance of the rendering process for the at least one second sub-workload prior to the completion of the rendering process for the at least one first sub-workload. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

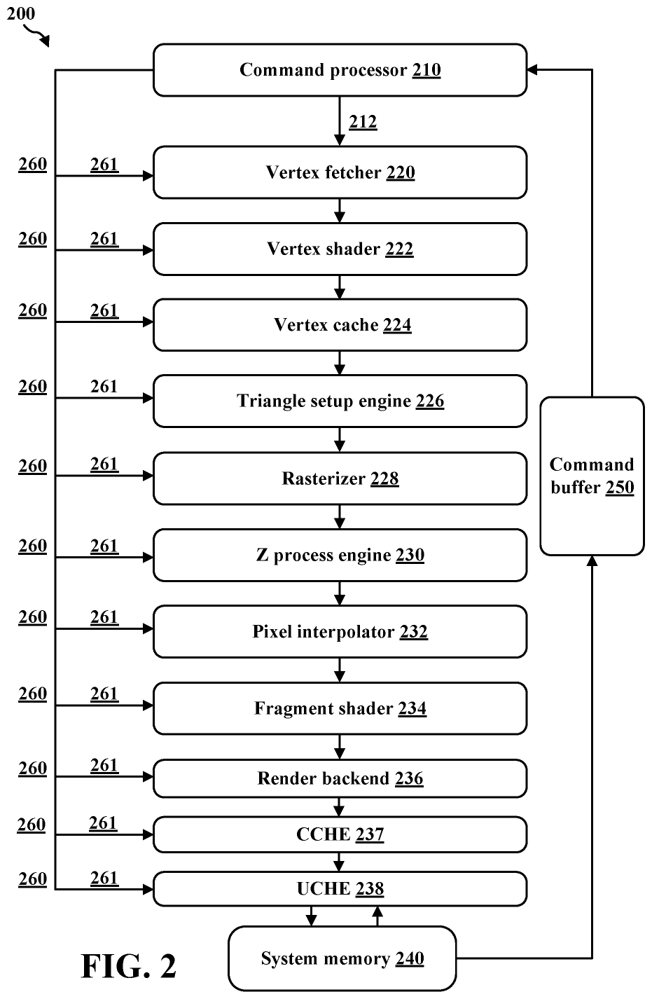

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

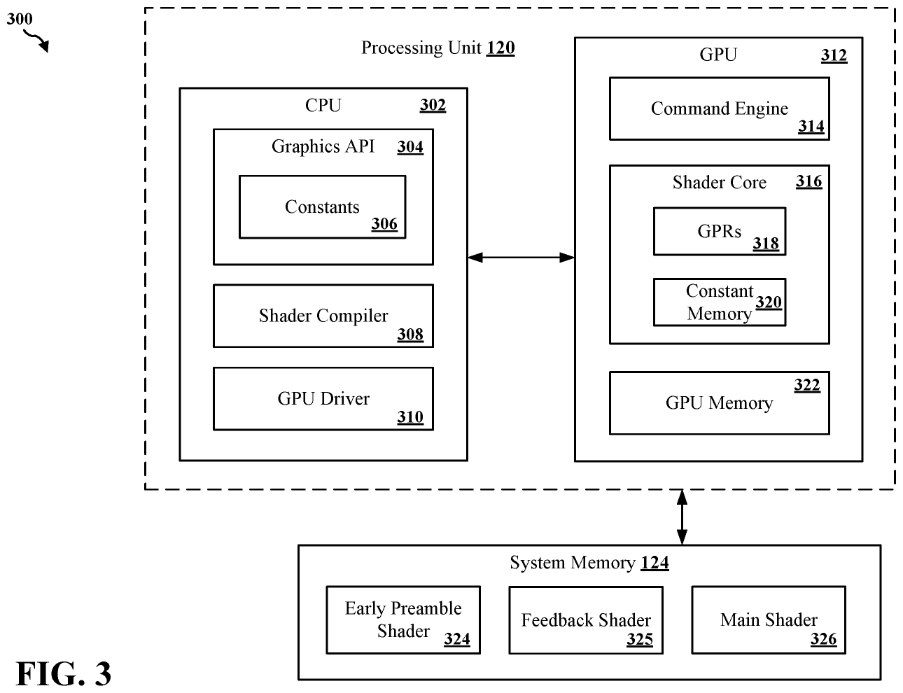

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

GPUs can render images in a variety of different ways. In some instances, GPUs can render an image using rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects, during the binning pass, a visibility stream can be constructed where visible primitives or draw calls can be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering.

In some aspects, GPUs can apply the drawing or rendering process to different bins or tiles. For instance, a GPU can render to one bin, and perform all the draws for the primitives or pixels in the bin. During the process of rendering to a bin, the render targets can be located in the GMEM. In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory used to drop primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

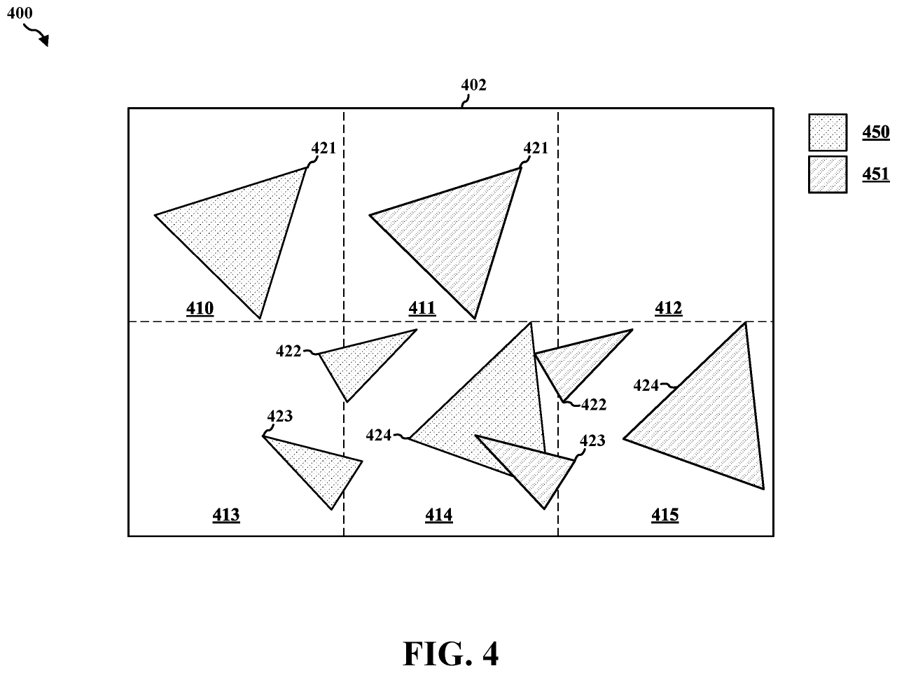

FIG. 4 illustrates image or surface 400, including multiple primitives divided into multiple bins. As shown in FIG. 4, image or surface 400 includes area 402, which includes primitives 421, 422, 423, and 424. The primitives 421, 422, 423, and 424 are divided or placed into different bins, e.g., bins 410, 411, 412, 413, 414, and 415. FIG. 4 illustrates an example of tiled rendering using multiple viewpoints for the primitives 421-424. For instance, primitives 421-424 are in first viewpoint 450 and second viewpoint 451. As such, the GPU processing or rendering the image or surface 400 including area 402 can utilize multiple viewpoints or multi-view rendering.

As indicated herein, GPUs or graphics processor units can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

In some aspects of graphics processing, GPU hardware may be divided into multiple sections, e.g., hardware for geometry processing and hardware for pixel processing. Scalable GPU hardware may be desirable in order to meet different throughputs across various market segments. Also, in some aspects, scalable hardware for pixel processing may be designed in a variety of ways. For instance, a screen may be divided into different parts and multiple pixel processing hardware modules (i.e., slices) may work independently on different parts of the screen. By changing the number of pixel slices, a scalable throughput may be achieved for different tiers. However, designing scalable geometry processing hardware has an inherent challenge of evenly distributing the workload across independently working hardware modules (i.e., geometry slices).

There are a number of issues that may be encountered when designing scalable geometry processing hardware. For instance, the variable size of a drawcall (i.e., a work unit) and an adaptive workload expansion in the middle of the geometry pipeline are some issues that may occur when designing scalable geometry processing hardware. Workloads across different drawcalls may vary, so tying each drawcall to a geometry slice may create uneven data downstream. Apart from this, an application program interface (API) may specify that a geometry pipeline may support adaptive workload expansion/reduction through different features, e.g., tessellation, geometry shading, and/or triangle culling.

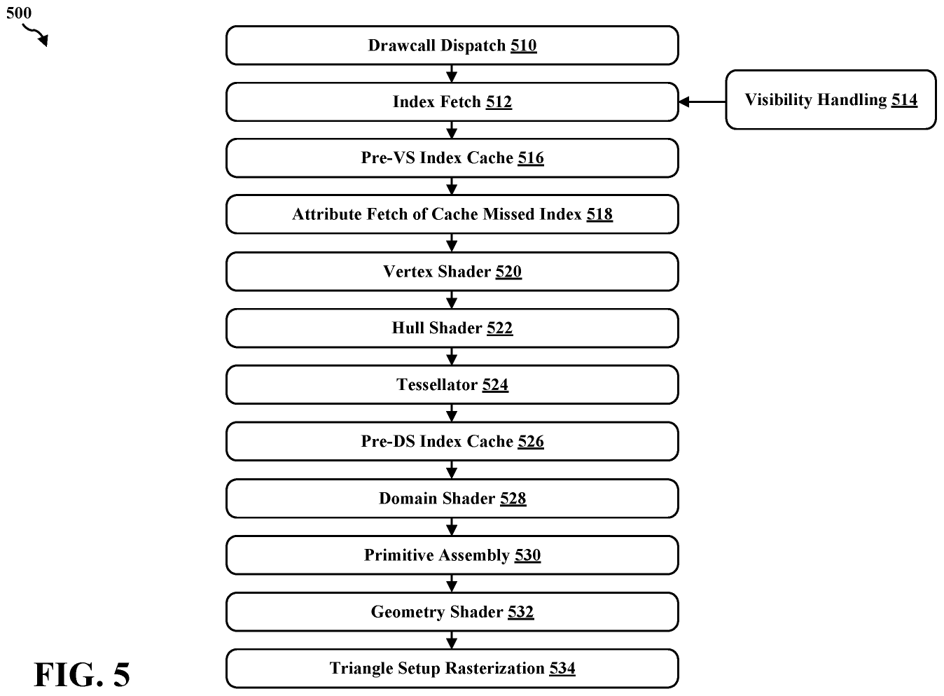

FIG. 5 is a diagram 500 illustrating an example geometry pipeline in a GPU. As depicted in FIG. 5, diagram 500 includes a drawcall dispatch 510, an index fetch 512, a visibility handling step 514, a pre-vertex shader index cache 516, an attribute fetch of a cache missed index 518, a vertex shader 520, a hull shader 522, a tessellator 524, a pre-domain shader index cache 526, a domain shader 528, a primitive assembly 530, a geometry shader 532, and a triangle setup rasterization 534. As shown in FIG. 5, after an index fetch 512, each primitive may be expanded to create multiple primitives, where an amplification factor may be determined during run-time. As such, sending primitives to different modules without considering an amplification factor may create an unequal workload in a downstream pipeline. Accordingly, this may prevent the achievement of an optimal throughput.

Another issue that may be encountered when designing scalable geometry processing hardware is visibility handling (e.g., tiled rendering) across multiple geometry slices. As indicated above, in tile-based rendering, the screen is divided into multiple bins, and a binning pass is used to generate a per-bin visibility stream (i.e., primitives that may be identified as visible in a bin). Also, the visibility stream may be used in multiple bin-rendering passes (e.g., dropping invisible primitives from processing) to render the whole screen. Because of different visibilities of primitives, the workload pattern in each bin-rendering pass may vary significantly from a binning pass. A workload distribution scheme may need to ensure that an even workload (including amplification) is distributed to each geometry slice (even when accounting for the potential disparity in visibility).

In some aspects, different types of GPU hardware may support different types of workload execution. For instance, GPU hardware may support concurrent execution of different workloads. Concurrent execution may refer to the simultaneous execution of workloads at a GPU. Also, concurrent execution may refer to the execution of workloads in parallel at a GPU. GPU hardware may also support concurrent execution of different workloads in a time-shared manner. In some instances, concurrent execution of different workloads in a time-shared manner may improve the performance per area at the GPU. However, in other instances, concurrent execution of different workloads in a time-shared manner may reduce the performance per area at the GPU. Additionally, different types of workloads may take a different amount of processing time in various stages of the GPU pipeline. Also, these types of workloads may introduce inefficiency in GPU hardware utilization.

In some aspects, scheduling algorithms in order to time-share the GPU hardware may sequence the workload to achieve the best utilization of GPU hardware. However, some types of workloads may block the execution of other successive workloads. For instance, some workloads with a higher specification for a resource (e.g., memory access latency) may block the execution of other successive workloads, which may have reduced resource specification and a faster execution time (e.g., head of line blocking). In turn, this may reduce the overall hardware efficiency at the GPU. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

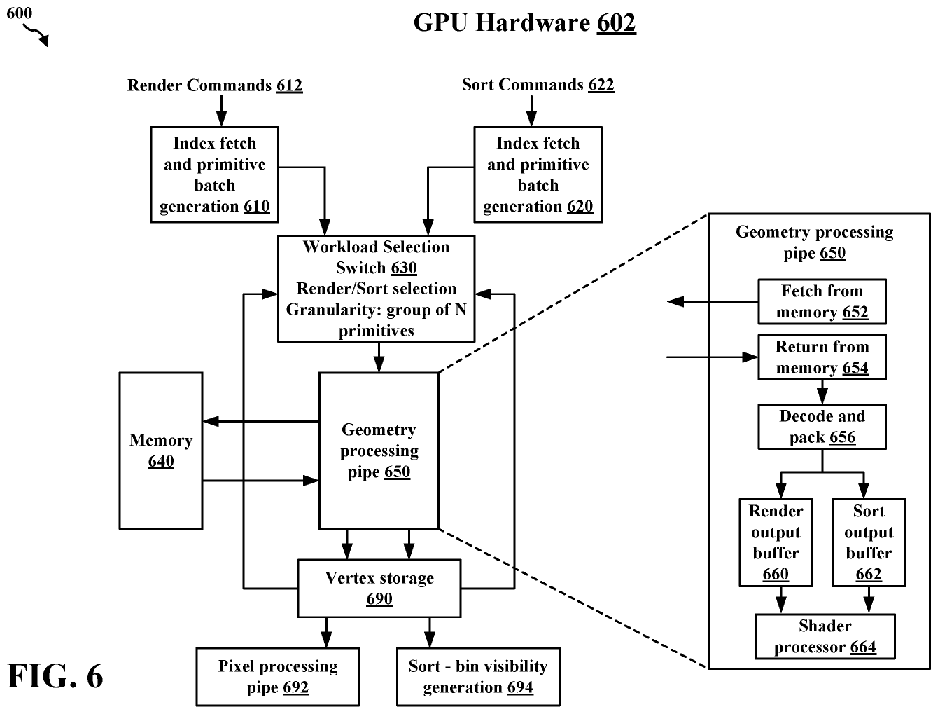

FIG. 6 illustrates diagram 600 including one example of GPU hardware. More specifically, diagram 600 depicts a time-shared GPU hardware for concurrent binning. As shown in FIG. 6, diagram 600 includes GPU hardware 602 including index fetch and primitive batch generation component 610, index fetch and primitive batch generation component 620, workload selection switch 630, memory 640, geometry processing pipe 650, vertex storage component 690, pixel processing pipe 692, and sort-bin visibility generation component 694. As shown in FIG. 6, render commands 612 may be input to index fetch and primitive batch generation component 610, which may be output to workload selection switch 630. Similarly, sort commands 622 may be input to index fetch and primitive batch generation component 620, which may be output to workload selection switch 630. The workload selection switch 630 may have a render/sort selection capability, as well as a certain granularity (e.g., a granularity for a group of N primitives). Also, the workload selection switch 630 may be referred to as a workload selection switch component, switch component, workload selection component, or selection component. The “switch” may refers to a switch in the selection of render/sorting workloads. The output of workload selection switch 630 may be sent to geometry processing pipe 650, which may communicate with memory 640. The geometry processing pipe 650 may include fetch from memory component 652, return from memory component 654, decode and pack component 656, render output buffer 660, sort output buffer 662, and shader processor 664. Also, the output of geometry processing pipe 650 may be sent to vertex storage component 690, which may be sent to pixel processing pipe 692 and sort-bin visibility generation component 694.

As shown in FIG. 6, geometry pipe hardware (e.g., geometry processing pipe 650) may be time shared between tile sorting and tile render workloads. Also, a scheduling algorithm (e.g., workload selection switch 630) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 6, the workload selection switch 630 may have a granularity of a group of N primitives. For instance, for concurrent binning, the workload distribution granularity may be a primitive batch (e.g., a set of N primitives).

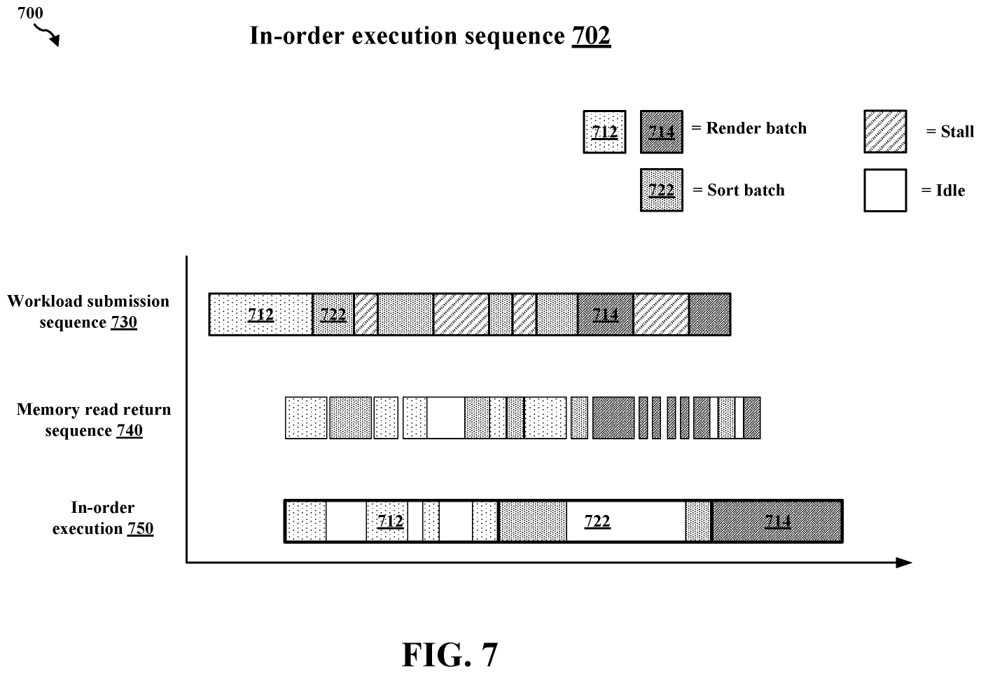

Certain types of workloads (e.g., sorting workloads) may face higher memory access latencies compared to other types of workloads (e.g., render workloads). For example, render workloads may be of higher priority than sorting workloads, which may face higher memory access latencies. In some aspects, if these types of workloads (e.g., sorting workloads) are executed in-order as per the scheduled workload sequence and granularity, there may be a reduction in hardware efficiency. For instance, if these types of workloads (e.g., sorting workloads) are executed in-order as per the scheduled workload sequence and granularity, a certain workload block (e.g., a head-of-line block) may occur, thus reducing the hardware efficiency. This type of scenario is shown in FIG. 7.

FIG. 7 illustrates diagram 700 including one example of a workload execution sequence. More specifically, diagram 700 depicts an in-order workload execution sequence for a GPU (i.e., a scheduled execution order). As shown in FIG. 7, diagram 700 includes in-order execution sequence 702 including render batch 712, render batch 714, sort batch 722, workload submission sequence 730, memory read return sequence 740, and in-order execution 750. FIG. 7 depicts that in-order workload execution causes both stalls during workload submission sequence 730, as well as idle periods during in-order execution 750. For example, during workload submission sequence 730, there are stalls between each sort batch 722 and each render batch 714. Also, during in-order execution 750, there are idle periods between each render batch 714 and each sort batch 722.

FIG. 7 illustrates that if certain types of workloads (e.g., sorting workloads) are executed in-order as per the scheduled workload sequence and granularity, there may be a reduction in hardware efficiency. As shown in FIG. 7, consider a workload submission sequence 730, as determined by the workload selection switch component in FIG. 6, to be 712, 722, and 714, where 712 and 714 are render batches and 722 is a sorting batch. Each of these batches may need to fetch data from memory (e.g., memory 640) and send it to shader processor (e.g., shader processor 664) for further processing. In some aspects, there may be a limit on how many requests can be made without processing the returned data (e.g., an OT limit). Furthermore, returns from memory 640 may be out-of-order, such that earlier requests may obtain granted data after grants for later requests. As shown in FIG. 7, some of the memory accesses for 722 may be granted before all accesses for 712 and most accesses for 714 to memory were granted before the last chunk of 722 accesses. Also, a 722 batch submission may be stalled multiple times (e.g., due to on-chip storage (OT) limit) as the pipeline may execute 712 first, even when it has some 722 data available for further processing and the shader processor is idle. Similar stalls may be seen at the 714 submission due to similar reasons.

The example in FIG. 7 illustrates a problem at the vertex data fetch and decode stage in the geometry pipeline. Similar problems exist at the shader processor input stage. For instance, the output buffers may be ready with data, but may not be processed further as the GPU pipeline may choose to follow a pre-determined execution order. In general, this problem may show up at any GPU pipelined hardware that is shared for the execution of multiple types of threads with different execution profiles (e.g., memory latency, arithmetic logic unit (ALU) execution time, etc.). That is, delay issues may exist if workloads are executed in order, such that there may be stalling with one workload. For example, a long and time-consuming workload (e.g., 712 or 722) may result in stalling, as shown in FIG. 7. Indeed, that may be idle periods and/or stalling in workload execution due to the GPU hardware reading the memory in order. This may result in delayed processing times, as well as an increased amount of processing power at the GPU. Based on the above, it may be beneficial to alter an execution order for workloads. That is, it may be beneficial to execute workloads out of a certain order (e.g., a pre-defined workload execution order). Further, it may be beneficial for certain types of hardware (e.g., time-shared hardware) to execute workloads out-of-order. For instance, it may be beneficial for a time-shared GPU processing pipeline (i.e., the same processing pipeline that executes multiple GPU workloads) to execute workloads out-of-order.

Aspects of the present disclosure may alter an execution order for certain types of workloads (e.g., graphics workloads). For instance, aspects of the present disclosure may execute workloads out of a certain order (e.g., a pre-defined workload execution order). That is, aspects presented herein may utilize certain types of hardware (e.g., time-shared hardware) to execute workloads out-of-order. Moreover, aspects presented herein may utilize a time-shared GPU processing pipeline to execute certain workloads (e.g., graphics workloads) in an out-of-order timeline (i.e., an execution order that is different from a scheduled execution order). Aspects presented herein may execute workloads out-of-order for a time-shared processing pipe, which may result in a faster and more efficient execution of workloads. Indeed, by executing workloads in an out-of-order fashion (or as data becomes available), aspects presented herein may avoid any stalls or idle periods during workload execution. By doing so, aspects presented herein may execute workloads more efficiently.

Aspects presented herein utilize a technique to improve hardware efficiency of GPU hardware by allowing out-of-order execution. For instance, aspects presented herein may utilize out-of-order execution within sorting and rendering workload chunks (e.g., a primitive batch). In some instances, each workload chunk may be divided into sets of M vertex attributes, where the sub-chunks may be allowed to execute out-of-order (e.g., in an order that is different from a scheduled order) based on data availability. For example, aspects presented herein may utilize a proposed scheme where certain workloads (e.g., workloads A, B, and C) are divided into sets of M vertex attributes (e.g., attributes 1, 2, 3, etc.). These workload sub-chunks may be executed in the order of data returned from memory, thereby ignoring the scheduled order. By doing so, this may eliminate certain types of delays (e.g., a head-of-line block) and thus improves the overall GPU hardware efficiency.

Aspects presented herein may utilize techniques to improve hardware efficiency of GPU hardware execution order to be different from a scheduled execution order. For instance, aspects presented herein may allow out-of-order execution (i.e., an execution order that is different from a scheduled execution order) within certain types of workloads. For example, aspects presented herein may allow out-of-order execution for sorting and rendering workload chunks (e.g., primitive batches). Based on a pipeline stage, aspects presented herein may select an appropriate granularity of workload chunk size. The size of the workload chunk may be a different size at different stages of the pipeline. Also, this may be subject to optimal performance specifications and/or area constraints of the pipeline. In some instances, the execution may occur in-order within the chunk (i.e., in a scheduled execution order), but chunks may be selected out-of-order or an out-of-order execution (i.e., execution order that is different from a scheduled execution order).

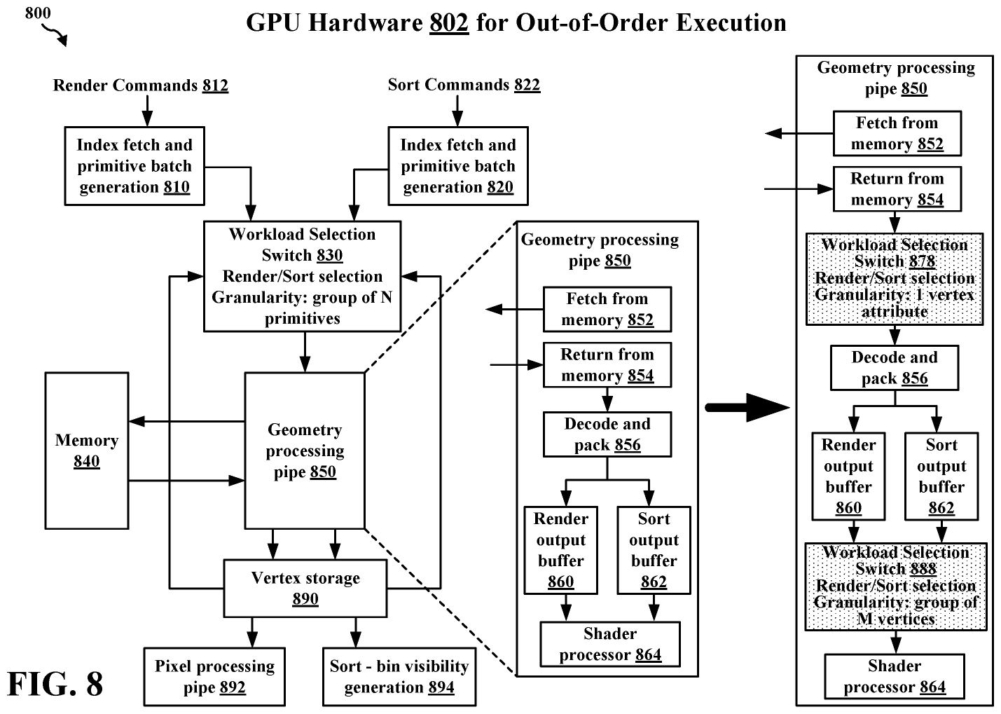

FIG. 8 illustrates diagram 800 including one example of GPU hardware. More specifically, diagram 800 depicts a time-shared GPU hardware for out-of-order workload execution (i.e., an execution order that is different from a scheduled execution order). As shown in FIG. 8, diagram 800 includes GPU hardware 802 including index fetch and primitive batch generation component 810, index fetch and primitive batch generation component 820, workload selection switch 830, memory 840, geometry processing pipe 850, vertex storage component 890, pixel processing pipe 892, and sort-bin visibility generation component 894. As shown in FIG. 8, render commands 812 may be input to index fetch and primitive batch generation component 810, which may be output to workload selection switch 830. Similarly, sort commands 822 may be input to index fetch and primitive batch generation component 820, which may be output to workload selection switch 830. The workload selection switch 830 may have a render/sort selection capability, as well as a certain granularity (e.g., a granularity of a group of N primitives). The output of workload selection switch 830 may be sent to geometry processing pipe 850, which may communicate with memory 840. In some aspects, the geometry processing pipe 850 may include fetch from memory component 852, return from memory component 854, decode and pack component 856, render output buffer 860, sort output buffer 862, and shader processor 864. The output of geometry processing pipe 850 may be sent to vertex storage component 890, which may be sent to pixel processing pipe 892 and sort-bin visibility generation component 894.

In some aspects, the geometry processing pipe 850 may include additional components, such as additional workload selection switch components. For example, the geometry processing pipe 850 may include workload selection switch 878 and/or workload selection switch 888. The workload selection switch 878 may have a render/sort selection capability, as well as a certain granularity (e.g., a granularity of 1 vertex attribute). Also, the workload selection switch 888 may have a render/sort selection capability, as well as a certain granularity (e.g., a granularity of a group of M primitives). The workload selection switch 878 and workload selection switch 888 may help to determine an out-of-order workload execution (i.e., an execution order that is different from a scheduled execution order). That is, the scheduled execution order may be a certain order, but the workload selection switch 878 and workload selection switch 888 may help to determine an on-the-fly workload or an out-of-order workload that may help to eliminate certain delays during workload execution and improve the overall GPU hardware efficiency.

As shown in FIG. 8, geometry pipe hardware (e.g., geometry processing pipe 850) may be time shared between tile sorting and tile render workloads. Also, a scheduling algorithm (e.g., workload selection switch 830, workload selection switch 878, or workload selection switch 888) may consider the availability of GPU hardware for tile sorting and tile render workload. The granularity of a workload may be selected such that there is limited workload switching overhead. Also, the granularity of a workload may be selected such that one workload does not block the other. As shown in FIG. 8, the workload selection switch 830 may have a granularity of a group of N primitives, workload selection switch 878 may have a granularity of 1 vertex attribute, and workload selection switch 888 may have a granularity of a group of M primitives.

As depicted in FIG. 8, at the workload selection switch 878, the geometry pipeline may switch per vertex attribute data. This switch of per vertex attribute data may be based on the type of return received. This attribute may then be decoded, packed, and loaded into its respective output buffer for further processing. At workload selection switch 888, the granularity may be a certain set of vertices (e.g., a set of ‘M’ vertices). Also, these sub-chunks of workloads may be allowed to execute out-of-order (i.e., an execution order that is different from a scheduled or pre-defined execution order) at workload selection switch 888 based on data availability in the output buffer.

In some aspects, pre-allocated storage buffers for render and sort attributes may provide the support needed to allow out-of-order execution at workload selection switch 878 and workload selection switch 888. For instance, the shader processor 864 may choose to accept input from any buffer that is ready with its set of vertices (e.g., ‘M’ vertices). While this data is being loaded, workload selection switch 878 may independently select vertex attributes of render workload or sort workload based on the memory read returns. Also, workload selection switch 878 may select vertex attributes of render workload or sort workload based on the availability of space in the output buffers. Similar to the workload selection switch 630 in FIG. 6, workload selection switch 830, workload selection switch 878, and workload selection switch 888 may be referred to as a workload selection switch component, a switch component, a workload selection component, or a selection component. The “switch” may refers to a switch in the selection of render/sorting workloads.

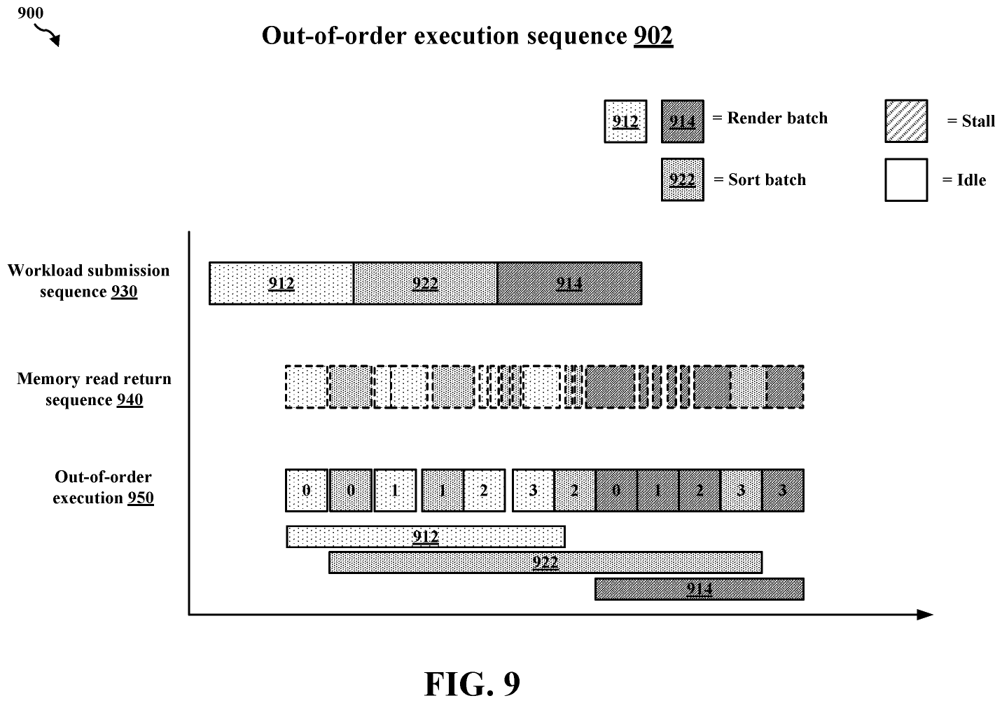

As indicated herein, certain types of workloads (e.g., sorting workloads) may face higher memory access latencies compared to other types of workloads (e.g., render workloads). For example, render workloads may be of higher priority than sorting workloads, which may face higher memory access latencies. In some aspects, if these types of workloads (e.g., sorting workloads) are executed out-of-order (i.e., an execution order that is different from a scheduled execution order), there may be an increase in hardware efficiency. For instance, if these types of workloads (e.g., sorting workloads) are executed out-of-order as per the scheduled workload sequence and granularity, a certain workload block (e.g., a head-of-line block) may not occur, thus increasing the hardware efficiency. This type of scenario that increases hardware efficiency is shown in FIG. 9.

FIG. 9 illustrates diagram 900 including one example of a workload execution sequence. More specifically, diagram 900 depicts an out-of-order workload execution sequence for a GPU (i.e., an execution order that is different from a scheduled or pre-defined execution order). As shown in FIG. 9, diagram 900 includes out-of-order execution sequence 902 including render batch 912, render batch 914, sort batch 922, workload submission sequence 930, memory read return sequence 940, and out-of-order execution 950. FIG. 9 depicts that out-of-order workload execution reduces/eliminates stalls during workload submission sequence 930, as well as reduces/eliminates idle periods during out-of-order execution 950. For example, during workload submission sequence 930, there are no stalls or delays between render batch 912, sort batch 922, and render batch 914. Also, during out-of-order execution 950, there are no idle periods between render batch 912, sort batch 922, and render batch 914. Indeed, FIG. 9 shows how the proposed out-of-order execution scheme makes the execution of workloads faster and more efficient by utilizing hardware with an out-of-order execution order.

FIG. 9 illustrates that if certain types of workloads (e.g., sorting workloads) are executed out-of-order as per the scheduled workload sequence and granularity, there may be an increase in hardware efficiency. As shown in FIG. 9, consider a workload submission sequence 930, as determined by the workload selection switch components in FIG. 8, to be 912, 922, and 914, where 912 and 914 are render batches and 922 is a sorting batch. Each of these batches may need to fetch data from memory (e.g., memory 840) and send it to shader processor (e.g., shader processor 864) for further processing. In some aspects, there may be a limit on how many requests can be made without processing the returned data. Furthermore, returns from memory 840 may be out-of-order, such that earlier requests may obtain granted data before and/or after grants for later requests. Also, batch submissions for 912, 922, and 914 may not be stalled or delayed, as the pipeline may execute 912, 922, and 914 as data becomes available for further processing. As such, workload execution and/or the shader processor (e.g., shader processor 864) may not be idle due to the batch submissions for 912, 922, and 914 being executed as data becomes available.

As depicted in FIG. 9, as workloads are executed when data becomes available (rather than in a precise/scheduled order), the proposed out-of-order execution scheme makes the execution of workloads faster and more efficient. Aspects presented herein may execute workloads faster and more efficiently because of workload division (i.e., workload chunking). That is, aspects presented herein may divide (i.e., chunk) the workloads into smaller sub-workloads, so the workloads are more easily allocated into different data. By doing so, aspects presented herein may execute workloads as data becomes available (rather than in a precise order). This may allow the pipeline to more efficiently execute workloads, as the pipeline is not waiting for data to be sent in a precise, scheduled order. Indeed, the pipeline may execute data in an efficient manner as data becomes available. Also, aspects presented herein may allow dedicated storage for the out-of-order execution.

As shown in FIGS. 8 and 9, aspects presented herein may allow a GPU (e.g., GPU hardware 802) to obtain an indication of a plurality of workloads for graphics processing, where the plurality of workloads corresponds to a workload order for a workload submission sequence. GPU hardware 802 may also perform a binning process for a first workload of the plurality of workloads, where the first workload is first in the workload order. GPU hardware 802 may also divide the first workload into a plurality of first sub-workloads and a second workload of the plurality of workloads into a plurality of second sub-workloads, where the second workload is second in the workload order. Additionally, GPU hardware 802 may allocate the plurality of first sub-workloads and the plurality of second sub-workloads to a preconfigured storage after the division of the first workload and the second workload. GPU hardware 802 may also execute a memory read process for the at least one first sub-workload prior to the performance of the rendering process for the at least one first sub-workload. Moreover, GPU hardware 802 may divide each of the plurality of first primitive batches into a plurality of first primitive sub-batches and each of the plurality of second primitive batches into a plurality of second primitive sub-batches. GPU hardware 802 may also combine each of the plurality of first primitive sub-batches into a group of first vertices and each of the plurality of second primitive sub-batches into a group of second vertices, where the group of first vertices is associated with a first granularity and the group of second vertices is associated with a second granularity. GPU hardware 802 may also execute, at a shader processor (SP) of a graphics processing unit (GPU), the group of first vertices at the first granularity and the group of second vertices at the second granularity. Further, GPU hardware 802 may perform, upon completion of the binning process for the first workload, a rendering process for at least one first sub-workload of the plurality of first sub-workloads and a binning process for at least one second sub-workload of the plurality of second sub-workloads. GPU hardware 802 may also execute a memory read process for the at least one second sub-workload prior to the completion of the rendering process for the at least one first sub-workload and prior to the performance of the rendering process for the at least one second sub-workload. GPU hardware 802 may also perform a rendering process for the at least one second sub-workload prior to a completion of the rendering process for the at least one first sub-workload. GPU hardware 802 may also output an indication of the performance of the rendering process for the at least one second sub-workload prior to the completion of the rendering process for the at least one first sub-workload.

Aspects of the present disclosure may include a number of benefits or advantages. For instance, aspects presented herein may alter an execution order for certain types of workloads (e.g., graphics workloads). That is, aspects of the present disclosure may execute workloads out of a certain order (e.g., a pre-defined workload execution order). Aspects presented herein may utilize certain types of hardware (e.g., time-shared hardware) to execute workloads out-of-order. Also, aspects presented herein may utilize a time-shared GPU processing pipeline to execute certain workloads (e.g., graphics workloads) in an out-of-order timeline. Aspects presented herein may execute workloads out-of-order for a time-shared processing pipe, which may result in a faster and more efficient execution of workloads. By executing workloads in an out-of-order fashion, aspects presented herein may avoid any stalls or idle periods during workload execution. That is, aspects presented herein may execute workloads more efficiently. Further, aspects presented herein may experience an increase in terms of frames-per-second (FPS) execution. For example, aspects presented herein may experience an execution increase of 2% or 2.25% FPS.

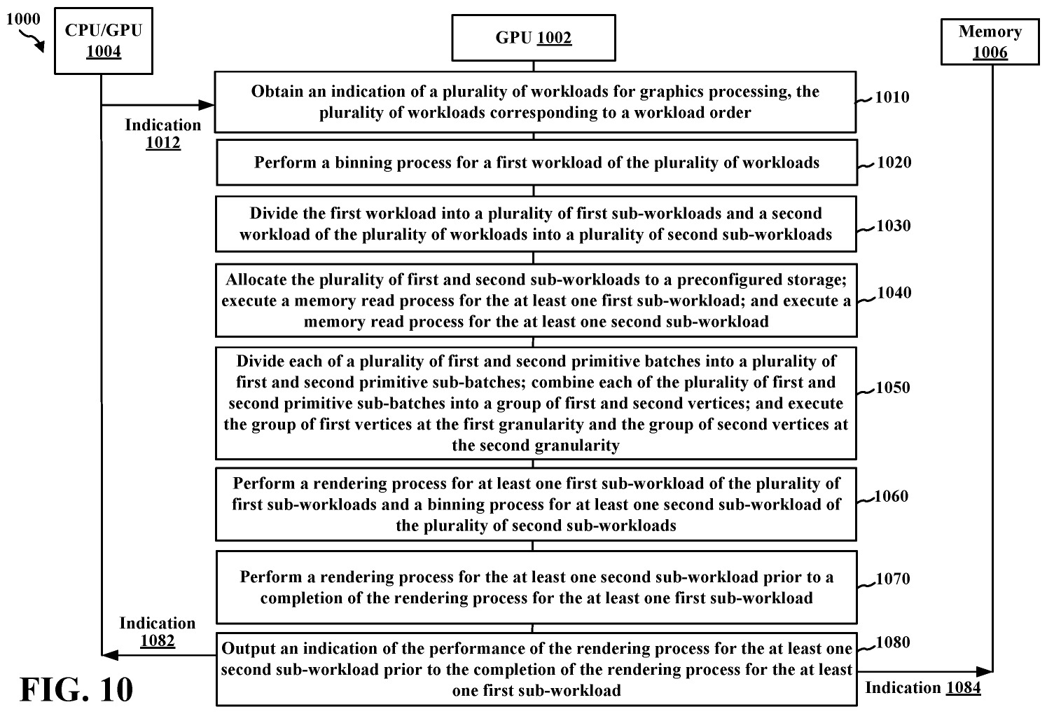

FIG. 10 is a communication flow diagram 1000 of graphics processing in accordance with one or more techniques of this disclosure. As shown in FIG. 10, diagram 1000 includes example communications between GPU 1002 (e.g., a GPU, a cache at a GPU, a GPU component, another graphics processor, a CPU, a CPU component, or another central processor), CPU/GPU 1004 (e.g., a GPU, a cache at a GPU, a GPU component, another graphics processor, a CPU, a CPU component, or another central processor), and memory 1006 (e.g., a memory, a cache, a system memory, a graphics memory, a memory or cache at a CPU, or a memory or cache at a GPU), in accordance with one or more techniques of this disclosure.

At 1010, GPU 1002 may obtain an indication of a plurality of workloads for graphics processing, where the plurality of workloads corresponds to a workload order for a workload submission sequence. For example, GPU 1002 may obtain indication 1012 from CPU/GPU 1004.

At 1020, GPU 1002 may perform a binning process for a first workload of the plurality of workloads, where the first workload is first in the workload order.

At 1030, GPU 1002 may divide the first workload into a plurality of first sub-workloads and a second workload of the plurality of workloads into a plurality of second sub-workloads, where the second workload is second in the workload order. In some aspects, the plurality of first sub-workloads may correspond to a plurality of first primitive batches and the plurality of second sub-workloads may correspond to a plurality of second primitive batches. Also, the division of the first workload into the plurality of first sub-workloads and the division of the second workload into the plurality of second sub-workloads may be performed at a graphics processing unit (GPU).

At 1040, GPU 1002 may allocate the plurality of first sub-workloads and the plurality of second sub-workloads to a preconfigured storage after the division of the first workload and the second workload. In some aspects, the preconfigured storage may be an on-chip storage at a graphics processing unit (GPU).

Also, at 1040, GPU 1002 may execute a memory read process for the at least one first sub-workload prior to the performance of the rendering process for the at least one first sub-workload. In some aspects, executing the memory read process for the at least one first sub-workload may comprise retrieving data for the at least one first sub-workload from a memory. Also, the rendering process for the at least one second sub-workload may be started prior to a completion of the memory read process for the at least one second sub-workload.

Also, at 1040, GPU 1002 may execute a memory read process for the at least one second sub-workload prior to the completion of the rendering process for the at least one first sub-workload and prior to the performance of the rendering process for the at least one second sub-workload. In some aspects, executing the memory read process for the at least one second sub-workload may comprise retrieving data for the at least one second sub-workload from the memory.

At 1050, GPU 1002 may divide each of the plurality of first primitive batches into a plurality of first primitive sub-batches and each of the plurality of second primitive batches into a plurality of second primitive sub-batches. In some aspects, the plurality of first primitive sub-batches may correspond to at least one first vertex attribute and the plurality of second primitive sub-batches may correspond to at least one second vertex attribute.

Also, at 1050, GPU 1002 may combine each of the plurality of first primitive sub-batches into a group of first vertices and each of the plurality of second primitive sub-batches into a group of second vertices, where the group of first vertices is associated with a first granularity and the group of second vertices is associated with a second granularity.

Also, at 1050, GPU 1002 may execute, at a shader processor (SP) of a graphics processing unit (GPU), the group of first vertices at the first granularity and the group of second vertices at the second granularity.

At 1060, GPU 1002 may perform, upon completion of the binning process for the first workload, a rendering process for at least one first sub-workload of the plurality of first sub-workloads and a binning process for at least one second sub-workload of the plurality of second sub-workloads. In some aspects, the binning process for the first workload may be a sorting process for the first workload and the binning process for the second workload may be the sorting process for the second workload.

At 1070, GPU 1002 may perform a rendering process for the at least one second sub-workload prior to a completion of the rendering process for the at least one first sub-workload. In some aspects, the performance of the rendering process for the at least one first sub-workload and the performance of the binning process for the at least one second sub-workload may be simultaneous. Also, the performance of the rendering process for the at least one first sub-workload and the performance of the binning process for the at least one second sub-workload may be in parallel. In some instances, the completion of the rendering process for the at least one first sub-workload may be prior to a completion of the rendering process for the at least one second sub-workload.

At 1080, GPU 1002 may output an indication of the performance of the rendering process for the at least one second sub-workload prior to the completion of the rendering process for the at least one first sub-workload. In some aspects, outputting the indication of the performance of the rendering process for the at least one second sub-workload may comprise transmitting the indication of the performance of the rendering process for the at least one second sub-workload. For example, GPU 1002 may transmit indication 1082 to CPU/GPU 1004. Also, outputting the indication of the performance of the rendering process for the at least one second sub-workload may comprise storing the indication of the performance of the rendering process for the at least one second sub-workload. For example, GPU 1002 may store indication 1084 in memory 1006.

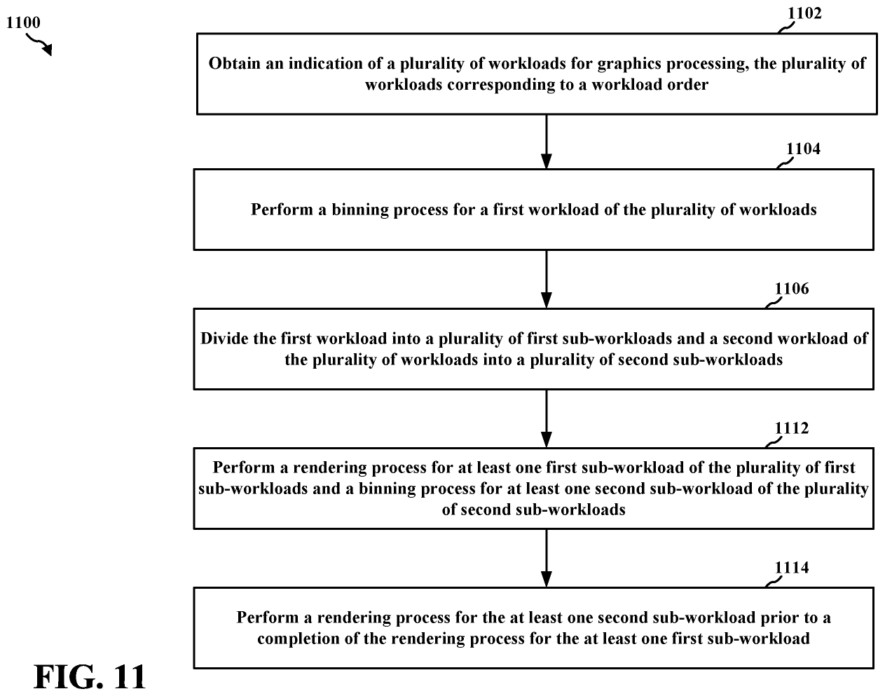

FIG. 11 is a flowchart 1100 of an example method of graphics processing in accordance with one or more techniques of this disclosure. The method may be performed by a GPU (e.g., a GPU, a cache at a GPU, a GPU component, another graphics processor, a CPU, a CPU component, or another central processor), a CPU (e.g., a CPU, a cache at a CPU, a CPU component, another central processor, a GPU, a GPU component, or another graphics processor), a display driver integrated circuit (DDIC), an apparatus for data or graphics processing, a wireless communication device, and/or any apparatus that may perform data or graphics processing as used in connection with the examples of FIGS. 1-10.

At 1102, the GPU may obtain an indication of a plurality of workloads for graphics processing, where the plurality of workloads corresponds to a workload order for a workload submission sequence, as described in connection with the examples in FIGS. 1-10. For example, as described in 1010 of FIG. 10, GPU 1002 may obtain an indication of a plurality of workloads for graphics processing, where the plurality of workloads corresponds to a workload order for a workload submission sequence. Further, step 1102 may be performed by processing unit 120 in FIG. 1.

At 1104, the GPU may perform a binning process for a first workload of the plurality of workloads, where the first workload is first in the workload order, as described in connection with the examples in FIGS. 1-10. For example, as described in 1020 of FIG. 10, GPU 1002 may perform a binning process for a first workload of the plurality of workloads, where the first workload is first in the workload order. Further, step 1104 may be performed by processing unit 120 in FIG. 1.

At 1106, the GPU may divide the first workload into a plurality of first sub-workloads and a second workload of the plurality of workloads into a plurality of second sub-workloads, where the second workload is second in the workload order, as described in connection with the examples in FIGS. 1-10. For example, as described in 1030 of FIG. 10, GPU 1002 may divide the first workload into a plurality of first sub-workloads and a second workload of the plurality of workloads into a plurality of second sub-workloads, where the second workload is second in the workload order. Further, step 1106 may be performed by processing unit 120 in FIG. 1. In some aspects, the plurality of first sub-workloads may correspond to a plurality of first primitive batches and the plurality of second sub-workloads may correspond to a plurality of second primitive batches. Also, the division of the first workload into the plurality of first sub-workloads and the division of the second workload into the plurality of second sub-workloads may be performed at a graphics processing unit (GPU).

At 1112, the GPU may perform, upon completion of the binning process for the first workload, a rendering process for at least one first sub-workload of the plurality of first sub-workloads and a binning process for at least one second sub-workload of the plurality of second sub-workloads, as described in connection with the examples in FIGS. 1-10. For example, as described in 1060 of FIG. 10, GPU 1002 may perform, upon completion of the binning process for the first workload, a rendering process for at least one first sub-workload of the plurality of first sub-workloads and a binning process for at least one second sub-workload of the plurality of second sub-workloads. Further, step 1112 may be performed by processing unit 120 in FIG. 1. In some aspects, the binning process for the first workload may be a sorting process for the first workload and the binning process for the second workload may be the sorting process for the second workload.

At 1114, the GPU may perform a rendering process for the at least one second sub-workload prior to a completion of the rendering process for the at least one first sub-workload, as described in connection with the examples in FIGS. 1-10. For example, as described in 1070 of FIG. 10, GPU 1002 may perform a rendering process for the at least one second sub-workload prior to a completion of the rendering process for the at least one first sub-workload. Further, step 1114 may be performed by processing unit 120 in FIG. 1. In some aspects, the performance of the rendering process for the at least one first sub-workload and the performance of the binning process for the at least one second sub-workload may be simultaneous. Also, the performance of the rendering process for the at least one first sub-workload and the performance of the binning process for the at least one second sub-workload may be in parallel. In some instances, the completion of the rendering process for the at least one first sub-workload may be prior to a completion of the rendering process for the at least one second sub-workload.

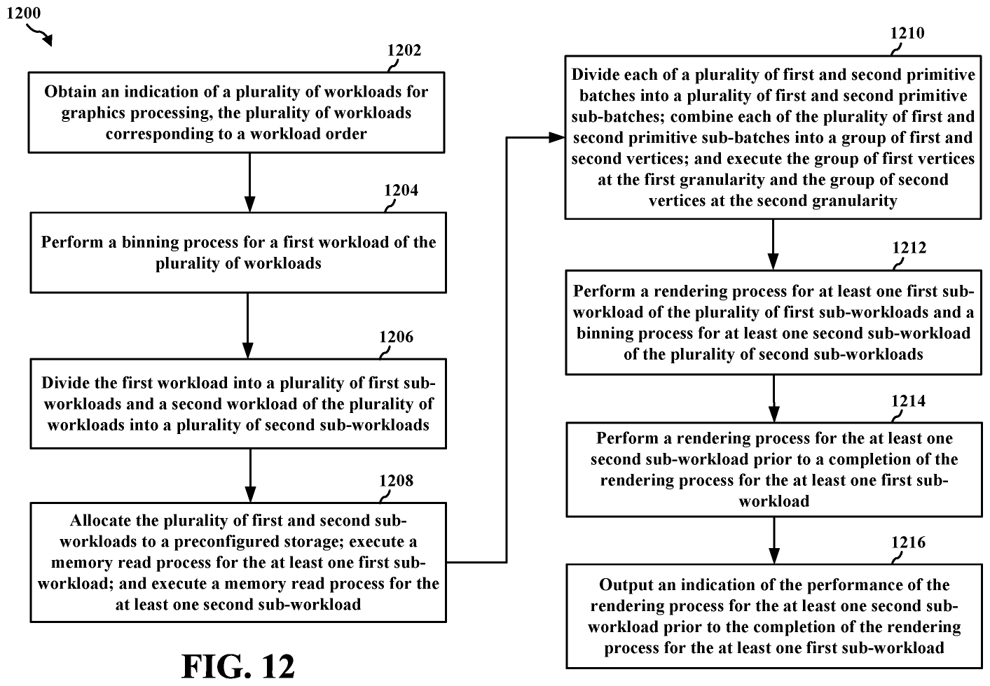

FIG. 12 is a flowchart 1200 of an example method of graphics processing in accordance with one or more techniques of this disclosure. The method may be performed by a GPU (e.g., a GPU, a cache at a GPU, a GPU component, another graphics processor, a CPU, a CPU component, or another central processor), a CPU (e.g., a CPU, a cache at a CPU, a CPU component, another central processor, a GPU, a GPU component, or another graphics processor), a display driver integrated circuit (DDIC), an apparatus for data or graphics processing, a wireless communication device, and/or any apparatus that may perform data or graphics processing as used in connection with the examples of FIGS. 1-10.

At 1202, the GPU may obtain an indication of a plurality of workloads for graphics processing, where the plurality of workloads corresponds to a workload order for a workload submission sequence, as described in connection with the examples in FIGS. 1-10. For example, as described in 1010 of FIG. 10, GPU 1002 may obtain an indication of a plurality of workloads for graphics processing, where the plurality of workloads corresponds to a workload order for a workload submission sequence. Further, step 1202 may be performed by processing unit 120 in FIG. 1.

At 1204, the GPU may perform a binning process for a first workload of the plurality of workloads, where the first workload is first in the workload order, as described in connection with the examples in FIGS. 1-10. For example, as described in 1020 of FIG. 10, GPU 1002 may perform a binning process for a first workload of the plurality of workloads, where the first workload is first in the workload order. Further, step 1204 may be performed by processing unit 120 in FIG. 1.

At 1206, the GPU may divide the first workload into a plurality of first sub-workloads and a second workload of the plurality of workloads into a plurality of second sub-workloads, where the second workload is second in the workload order, as described in connection with the examples in FIGS. 1-10. For example, as described in 1030 of FIG. 10, GPU 1002 may divide the first workload into a plurality of first sub-workloads and a second workload of the plurality of workloads into a plurality of second sub-workloads, where the second workload is second in the workload order. Further, step 1206 may be performed by processing unit 120 in FIG. 1. In some aspects, the plurality of first sub-workloads may correspond to a plurality of first primitive batches and the plurality of second sub-workloads may correspond to a plurality of second primitive batches. Also, the division of the first workload into the plurality of first sub-workloads and the division of the second workload into the plurality of second sub-workloads may be performed at a graphics processing unit (GPU).

At 1208, the GPU may allocate the plurality of first sub-workloads and the plurality of second sub-workloads to a preconfigured storage after the division of the first workload and the second workload, as described in connection with the examples in FIGS. 1-10. For example, as described in 1040 of FIG. 10, GPU 1002 may allocate the plurality of first sub-workloads and the plurality of second sub-workloads to a preconfigured storage after the division of the first workload and the second workload. Further, step 1208 may be performed by processing unit 120 in FIG. 1. In some aspects, the preconfigured storage may be an on-chip storage at a graphics processing unit (GPU).

Also, at 1208, the GPU may execute a memory read process for the at least one first sub-workload prior to the performance of the rendering process for the at least one first sub-workload, as described in connection with the examples in FIGS. 1-10. For example, as described in 1040 of FIG. 10, GPU 1002 may execute a memory read process for the at least one first sub-workload prior to the performance of the rendering process for the at least one first sub-workload. Further, step 1208 may be performed by processing unit 120 in FIG. 1. In some aspects, executing the memory read process for the at least one first sub-workload may comprise retrieving data for the at least one first sub-workload from a memory. Also, the rendering process for the at least one second sub-workload may be started prior to a completion of the memory read process for the at least one second sub-workload.

Also, at 1208, the GPU may execute a memory read process for the at least one second sub-workload prior to the completion of the rendering process for the at least one first sub-workload and prior to the performance of the rendering process for the at least one second sub-workload, as described in connection with the examples in FIGS. 1-10. For example, as described in 1040 of FIG. 10, GPU 1002 may execute a memory read process for the at least one second sub-workload prior to the completion of the rendering process for the at least one first sub-workload and prior to the performance of the rendering process for the at least one second sub-workload. Further, step 1208 may be performed by processing unit 120 in FIG. 1. In some aspects, executing the memory read process for the at least one second sub-workload may comprise retrieving data for the at least one second sub-workload from the memory.

At 1210, the GPU may divide each of the plurality of first primitive batches into a plurality of first primitive sub-batches and each of the plurality of second primitive batches into a plurality of second primitive sub-batches, as described in connection with the examples in FIGS. 1-10. For example, as described in 1050 of FIG. 10, GPU 1002 may divide each of the plurality of first primitive batches into a plurality of first primitive sub-batches and each of the plurality of second primitive batches into a plurality of second primitive sub-batches. Further, step 1210 may be performed by processing unit 120 in FIG. 1. In some aspects, the plurality of first primitive sub-batches may correspond to at least one first vertex attribute and the plurality of second primitive sub-batches may correspond to at least one second vertex attribute. Also, at 1210, the GPU may combine each of the plurality of first primitive sub-batches into a group of first vertices and each of the plurality of second primitive sub-batches into a group of second vertices, where the group of first vertices is associated with a first granularity and the group of second vertices is associated with a second granularity, as described in connection with the examples in FIGS. 1-10. For example, as described in 1050 of FIG. 10, GPU 1002 may combine each of the plurality of first primitive sub-batches into a group of first vertices and each of the plurality of second primitive sub-batches into a group of second vertices, where the group of first vertices is associated with a first granularity and the group of second vertices is associated with a second granularity. Further, step 1210 may be performed by processing unit 120 in FIG. 1.

Also, at 1210, the GPU may execute, at a shader processor (SP) of a graphics processing unit (GPU), the group of first vertices at the first granularity and the group of second vertices at the second granularity, as described in connection with the examples in FIGS. 1-10. For example, as described in 1050 of FIG. 10, GPU 1002 may execute, at a shader processor (SP) of a graphics processing unit (GPU), the group of first vertices at the first granularity and the group of second vertices at the second granularity. Further, step 1210 may be performed by processing unit 120 in FIG. 1.

At 1212, the GPU may perform, upon completion of the binning process for the first workload, a rendering process for at least one first sub-workload of the plurality of first sub-workloads and a binning process for at least one second sub-workload of the plurality of second sub-workloads, as described in connection with the examples in FIGS. 1-10. For example, as described in 1060 of FIG. 10, GPU 1002 may perform, upon completion of the binning process for the first workload, a rendering process for at least one first sub-workload of the plurality of first sub-workloads and a binning process for at least one second sub-workload of the plurality of second sub-workloads. Further, step 1212 may be performed by processing unit 120 in FIG. 1. In some aspects, the binning process for the first workload may be a sorting process for the first workload and the binning process for the second workload may be the sorting process for the second workload.

At 1214, the GPU may perform a rendering process for the at least one second sub-workload prior to a completion of the rendering process for the at least one first sub-workload, as described in connection with the examples in FIGS. 1-10. For example, as described in 1070 of FIG. 10, GPU 1002 may perform a rendering process for the at least one second sub-workload prior to a completion of the rendering process for the at least one first sub-workload. Further, step 1214 may be performed by processing unit 120 in FIG. 1. In some aspects, the performance of the rendering process for the at least one first sub-workload and the performance of the binning process for the at least one second sub-workload may be simultaneous. Also, the performance of the rendering process for the at least one first sub-workload and the performance of the binning process for the at least one second sub-workload may be in parallel. In some instances, the completion of the rendering process for the at least one first sub-workload may be prior to a completion of the rendering process for the at least one second sub-workload.

At 1216, the GPU may output an indication of the performance of the rendering process for the at least one second sub-workload prior to the completion of the rendering process for the at least one first sub-workload, as described in connection with the examples in FIGS. 1-10. For example, as described in 1080 of FIG. 10, GPU 1002 may output an indication of the performance of the rendering process for the at least one second sub-workload prior to the completion of the rendering process for the at least one first sub-workload. Further, step 1216 may be performed by processing unit 120 in FIG. 1. In some aspects, outputting the indication of the performance of the rendering process for the at least one second sub-workload may comprise transmitting the indication of the performance of the rendering process for the at least one second sub-workload. For example, GPU 1002 may transmit indication 1082 to CPU/GPU 1004. Also, outputting the indication of the performance of the rendering process for the at least one second sub-workload may comprise storing the indication of the performance of the rendering process for the at least one second sub-workload. For example, GPU 1002 may store indication 1084 in memory 1006.

In configurations, a method or an apparatus for data or graphics processing is provided. The apparatus may be a GPU (or other graphics processor), a CPU (or other central processor), a DDIC, an apparatus for graphics processing, and/or some other processor that may perform data or graphics processing. In aspects, the apparatus may be the processing unit 120 within the device 104, or may be some other hardware within the device 104 or another device. The apparatus, e.g., processing unit 120, may include means for obtaining an indication of a plurality of workloads for graphics processing, where the plurality of workloads corresponds to a workload order for a workload submission sequence. The apparatus, e.g., processing unit 120, may also include means for performing a binning process for a first workload of the plurality of workloads, where the first workload is first in the workload order. The apparatus, e.g., processing unit 120, may also include means for dividing the first workload into a plurality of first sub-workloads and a second workload of the plurality of workloads into a plurality of second sub-workloads, where the second workload is second in the workload order. The apparatus, e.g., processing unit 120, may also include means for performing, upon completion of the binning process for the first workload, a rendering process for at least one first sub-workload of the plurality of first sub-workloads and a binning process for at least one second sub-workload of the plurality of second sub-workloads. The apparatus, e.g., processing unit 120, may also include means for performing a rendering process for the at least one second sub-workload prior to a completion of the rendering process for the at least one first sub-workload. The apparatus, e.g., processing unit 120, may also include means for dividing each of the plurality of first primitive batches into a plurality of first primitive sub-batches and each of the plurality of second primitive batches into a plurality of second primitive sub-batches. The apparatus, e.g., processing unit 120, may also include means for combining each of the plurality of first primitive sub-batches into a group of first vertices and each of the plurality of second primitive sub-batches into a group of second vertices, where the group of first vertices is associated with a first granularity and the group of second vertices is associated with a second granularity. The apparatus, e.g., processing unit 120, may also include means for executing, at a shader processor (SP) of a graphics processing unit (GPU), the group of first vertices at the first granularity and the group of second vertices at the second granularity. The apparatus, e.g., processing unit 120, may also include means for executing a memory read process for the at least one first sub-workload prior to the performance of the rendering process for the at least one first sub-workload. The apparatus, e.g., processing unit 120, may also include means for executing a memory read process for the at least one second sub-workload prior to the completion of the rendering process for the at least one first sub-workload and prior to the performance of the rendering process for the at least one second sub-workload. The apparatus, e.g., processing unit 120, may also include means for allocating the plurality of first sub-workloads and the plurality of second sub-workloads to a preconfigured storage after the division of the first workload and the second workload. The apparatus, e.g., processing unit 120, may also include means for outputting an indication of the performance of the rendering process for the at least one second sub-workload prior to the completion of the rendering process for the at least one first sub-workload.

The subject matter described herein may be implemented to realize one or more benefits or advantages. For instance, the described graphics processing techniques may be used by a GPU, a CPU, a central processor, or some other processor that may perform graphics processing to implement the out-of-order execution techniques described herein. This may also be accomplished at a low cost compared to other graphics processing techniques. Moreover, the graphics processing techniques herein may improve or speed up graphics processing or execution. Further, the graphics processing techniques herein may improve resource or data utilization and/or resource efficiency. Additionally, aspects of the present disclosure may utilize out-of-order execution techniques in order to improve memory bandwidth efficiency and/or increase processing speed at a CPU, a GPU, or a DPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is an apparatus for graphics processing, including at least one memory and at least one processor coupled to the at least one memory and, based at least in part on information stored in the at least one memory, the at least one processor, individually or in any combination, is configured to: obtain an indication of a plurality of workloads for graphics processing, wherein the plurality of workloads corresponds to a workload order for a workload submission sequence; perform a binning process for a first workload of the plurality of workloads, wherein the first workload is first in the workload order; divide the first workload into a plurality of first sub-workloads and a second workload of the plurality of workloads into a plurality of second sub-workloads, wherein the second workload is second in the workload order; perform, upon completion of the binning process for the first workload, a rendering process for at least one first sub-workload of the plurality of first sub-workloads and a binning process for at least one second sub-workload of the plurality of second sub-workloads; and perform a rendering process for the at least one second sub-workload prior to a completion of the rendering process for the at least one first sub-workload.
Aspect 2 is the apparatus of aspect 1, wherein the plurality of first sub-workloads corresponds to a plurality of first primitive batches and the plurality of second sub-workloads corresponds to a plurality of second primitive batches.
Aspect 3 is the apparatus of aspect 2, wherein the at least one processor, individually or in any combination, is further configured to: divide each of the plurality of first primitive batches into a plurality of first primitive sub-batches and each of the plurality of second primitive batches into a plurality of second primitive sub-batches.
Aspect 4 is the apparatus of aspect 3, wherein the at least one processor, individually or in any combination, is further configured to: combine each of the plurality of first primitive sub-batches into a group of first vertices and each of the plurality of second primitive sub-batches into a group of second vertices, wherein the group of first vertices is associated with a first granularity and the group of second vertices is associated with a second granularity.
Aspect 5 is the apparatus of aspect 4, wherein the at least one processor, individually or in any combination, is further configured to: execute, at a shader processor (SP) of a graphics processing unit (GPU), the group of first vertices at the first granularity and the group of second vertices at the second granularity.
Aspect 6 is the apparatus of any of aspects 3 to 5, wherein the plurality of first primitive sub-batches corresponds to at least one first vertex attribute and the plurality of second primitive sub-batches corresponds to at least one second vertex attribute.
Aspect 7 is the apparatus of any of aspects 1 to 6, wherein the at least one processor, individually or in any combination, is further configured to: execute a memory read process for the at least one first sub-workload prior to the performance of the rendering process for the at least one first sub-workload.
Aspect 8 is the apparatus of aspect 7, wherein the at least one processor, individually or in any combination, is further configured to: execute a memory read process for the at least one second sub-workload prior to the completion of the rendering process for the at least one first sub-workload and prior to the performance of the rendering process for the at least one second sub-workload.
Aspect 9 is the apparatus of aspect 8, wherein to execute the memory read process for the at least one first sub-workload, the at least one processor, individually or in any combination, is configured to retrieve data for the at least one first sub-workload from a memory; and wherein to execute the memory read process for the at least one second sub-workload, the at least one processor, individually or in any combination, is configured to retrieve data for the at least one second sub-workload from the memory.
Aspect 10 is the apparatus of any of aspects 8 to 9, wherein the rendering process for the at least one second sub-workload is started prior to a completion of the memory read process for the at least one second sub-workload.
Aspect 11 is the apparatus of any of aspects 1 to 10, wherein the at least one processor, individually or in any combination, is further configured to: allocate the plurality of first sub-workloads and the plurality of second sub-workloads to a preconfigured storage after the division of the first workload and the second workload.
Aspect 12 is the apparatus of aspect 11, wherein the preconfigured storage is an on-chip storage at a graphics processing unit (GPU).
Aspect 13 is the apparatus of any of aspects 1 to 12, wherein the performance of the rendering process for the at least one first sub-workload and the performance of the binning process for the at least one second sub-workload are simultaneous.
Aspect 14 is the apparatus of any of aspects 1 to 12, wherein the performance of the rendering process for the at least one first sub-workload and the performance of the binning process for the at least one second sub-workload are in parallel.
Aspect 15 is the apparatus of any of aspects 1 to 14, wherein the completion of the rendering process for the at least one first sub-workload is prior to a completion of the rendering process for the at least one second sub-workload.
Aspect 16 is the apparatus of any of aspects 1 to 15, wherein the at least one processor, individually or in any combination, is further configured to: output an indication of the performance of the rendering process for the at least one second sub-workload prior to the completion of the rendering process for the at least one first sub-workload.
Aspect 17 is the apparatus of aspect 16, wherein to output the indication of the performance of the rendering process for the at least one second sub-workload, the at least one processor, individually or in any combination, is configured to: transmit the indication of the performance of the rendering process for the at least one second sub-workload; or store the indication of the performance of the rendering process for the at least one second sub-workload.
Aspect 18 is the apparatus of any of aspects 1 to 17, wherein the binning process for the first workload is a sorting process for the first workload and the binning process for the second workload is the sorting process for the second workload.
Aspect 19 is the apparatus of any of aspects 1 to 18, wherein the division of the first workload into the plurality of first sub-workloads and the division of the second workload into the plurality of second sub-workloads is performed at a graphics processing unit (GPU).
Aspect 20 is the apparatus of any of aspects 1 to 19, further including (i.e., comprising): at least one of an antenna or a transceiver coupled to the at least one processor, wherein to obtain the indication of the plurality of workloads, the at least one processor, individually or in any combination, is configured to: obtain, via at least one of the antenna or the transceiver, the indication of the plurality of workloads.
Aspect 21 is a method of graphics processing for implementing any of aspects 1 to 20.
Aspect 22 is an apparatus for graphics processing including means for implementing any of aspects 1 to 20.
Aspect 23 is a computer-readable medium (e.g., a non-transitory computer-readable medium) storing computer executable code (e.g., code for graphics processing), the code when executed by at least one processor causes the at least one processor to implement any of aspects 1 to 20.

What is claimed is:

1. An apparatus for graphics processing, comprising:
at least one memory; and
at least one processor coupled to the at least one memory and, based at least in part on information stored in the at least one memory, the at least one processor, individually or in any combination, is configured to:
obtain an indication of a plurality of workloads for the graphics processing, wherein the plurality of workloads corresponds to a workload order for a workload submission sequence;
perform a binning process for a first workload of the plurality of workloads, wherein the first workload is first in the workload order;
divide the first workload into a plurality of first sub-workloads and a second workload of the plurality of workloads into a plurality of second sub-workloads, wherein the second workload is second in the workload order;
perform, upon completion of the binning process for the first workload, a rendering process for at least one first sub-workload of the plurality of first sub-workloads and a binning process for at least one second sub-workload of the plurality of second sub-workloads; and
perform a rendering process for the at least one second sub-workload prior to a completion of the rendering process for the at least one first sub-workload.

2. The apparatus of claim 1, wherein the plurality of first sub-workloads corresponds to a plurality of first primitive batches and the plurality of second sub-workloads corresponds to a plurality of second primitive batches.

3. The apparatus of claim 2, wherein the at least one processor, individually or in any combination, is further configured to:
divide each of the plurality of first primitive batches into a plurality of first primitive sub-batches and each of the plurality of second primitive batches into a plurality of second primitive sub-batches.

4. The apparatus of claim 3, wherein the at least one processor, individually or in any combination, is further configured to:
combine each of the plurality of first primitive sub-batches into a group of first vertices and each of the plurality of second primitive sub-batches into a group of second vertices, wherein the group of first vertices is associated with a first granularity and the group of second vertices is associated with a second granularity.

5. The apparatus of claim 4, wherein the at least one processor, individually or in any combination, is further configured to:
execute, at a shader processor (SP) of a graphics processing unit (GPU), the group of first vertices at the first granularity and the group of second vertices at the second granularity.

6. The apparatus of claim 3, wherein the plurality of first primitive sub-batches corresponds to at least one first vertex attribute and the plurality of second primitive sub-batches corresponds to at least one second vertex attribute.

7. The apparatus of claim 1, wherein the at least one processor, individually or in any combination, is further configured to:
execute a memory read process for the at least one first sub-workload prior to the performance of the rendering process for the at least one first sub-workload.

8. The apparatus of claim 7, wherein the at least one processor, individually or in any combination, is further configured to:
execute the memory read process for the at least one second sub-workload prior to the completion of the rendering process for the at least one first sub-workload and prior to the performance of the rendering process for the at least one second sub-workload.

9. The apparatus of claim 8, wherein to execute the memory read process for the at least one first sub-workload, the at least one processor, individually or in any combination, is configured to retrieve data for the at least one first sub-workload from a memory; and
wherein to execute the memory read process for the at least one second sub-workload, the at least one processor, individually or in any combination, is configured to retrieve data for the at least one second sub-workload from the memory.

10. The apparatus of claim 8, wherein the rendering process for the at least one second sub-workload is started prior to a completion of the memory read process for the at least one second sub-workload.

11. The apparatus of claim 1, wherein the at least one processor, individually or in any combination, is further configured to:
allocate the plurality of first sub-workloads and the plurality of second sub-workloads to a preconfigured storage after the division of the first workload and the second workload.

12. The apparatus of claim 11, wherein the preconfigured storage is an on-chip storage at a graphics processing unit (GPU).

13. The apparatus of claim 1, wherein the performance of the rendering process for the at least one first sub-workload and the performance of the binning process for the at least one second sub-workload are simultaneous.

14. The apparatus of claim 1, wherein the performance of the rendering process for the at least one first sub-workload and the performance of the binning process for the at least one second sub-workload are in parallel.

15. The apparatus of claim 1, wherein the completion of the rendering process for the at least one first sub-workload is prior to a completion of the rendering process for the at least one second sub-workload.

16. The apparatus of claim 1, wherein the at least one processor, individually or in any combination, is further configured to:
output an indication of the performance of the rendering process for the at least one second sub-workload prior to the completion of the rendering process for the at least one first sub-workload.

17. The apparatus of claim 16, wherein to output the indication of the performance of the rendering process for the at least one second sub-workload, the at least one processor, individually or in any combination, is configured to:
transmit the indication of the performance of the rendering process for the at least one second sub-workload; or
store the indication of the performance of the rendering process for the at least one second sub-workload.

18. The apparatus of claim 1, wherein the binning process for the first workload is a sorting process for the first workload and the binning process for the second workload is the sorting process for the second workload; and
wherein the division of the first workload into the plurality of first sub-workloads and the division of the second workload into the plurality of second sub-workloads is performed at a graphics processing unit (GPU).

19. A method of graphics processing, comprising:
obtaining an indication of a plurality of workloads for the graphics processing, wherein the plurality of workloads corresponds to a workload order for a workload submission sequence;
performing a binning process for a first workload of the plurality of workloads, wherein the first workload is first in the workload order;
dividing the first workload into a plurality of first sub-workloads and a second workload of the plurality of workloads into a plurality of second sub-workloads, wherein the second workload is second in the workload order;
performing, upon completion of the binning process for the first workload, a rendering process for at least one first sub-workload of the plurality of first sub-workloads and a binning process for at least one second sub-workload of the plurality of second sub-workloads; and
performing a rendering process for the at least one second sub-workload prior to a completion of the rendering process for the at least one first sub-workload.

20. A computer-readable medium storing computer executable code for graphics processing, the code when executed by at least one processor causes the at least one processor to:
obtain an indication of a plurality of workloads for the graphics processing, wherein the plurality of workloads corresponds to a workload order for a workload submission sequence;
perform a binning process for a first workload of the plurality of workloads, wherein the first workload is first in the workload order;
divide the first workload into a plurality of first sub-workloads and a second workload of the plurality of workloads into a plurality of second sub-workloads, wherein the second workload is second in the workload order;
perform, upon completion of the binning process for the first workload, a rendering process for at least one first sub-workload of the plurality of first sub-workloads and a binning process for at least one second sub-workload of the plurality of second sub-workloads; and
perform a rendering process for the at least one second sub-workload prior to a completion of the rendering process for the at least one first sub-workload.
